(19) United States
(12) Patent Application Publication
(10) Pub. No.: US 2019/0094257 A1
(43) Pub. Date: Mar. 28, 2019

(54) IMPACT INDICATOR

(71) Applicant: ShockWatch, Inc., Dallas, TX (US)

(72) Inventor: Robbie Wardrup, Jacksboro, TX (US)

(21) Appl. No.: 16/137,741

(22) Filed: Sep. 21, 2018

Related U.S. Application Data
(60) Provisional application No. 62/606,423, filed on Sep. 22, 2017.
(60) Provisional application No. 62/762,580, filed on May 10, 2018.

(51) Int. Cl. G01P 15/03

(52) U.S. Cl. CPC G01P 15/038

(57) ABSTRACT

An impact indicator includes a first tube having an outer dimension, a second tube having an inner dimension greater than the outer dimension of the first tube, and wherein at least a portion of the first tube is disposed within the second tube. A first fluid is disposed and held within the first tube via capillary action until a predetermined level of an acceleration event is received. A second fluid is disposed and held within the second tube via capillary action, and the second fluid is spaced apart from the first fluid by at least one plug. Responsive to receiving the predetermined level of the acceleration event, at least a portion of the first fluid exits the first tube and mixes into the second fluid to create a change in color of the second fluid to provide a visual indication of the acceleration event.

### BACKGROUND

During manufacturing, storage or transit, many types of objects need to be monitored due to the sensitivity or fragility of the objects. For example, some types of objects may be susceptible to damage if dropped or a significant impact is received. Thus, for quality control purposes and/or the general monitoring of transportation conditions, it is desirable to determine and/or verify the environmental conditions to which the object has been exposed.

### BRIEF SUMMARY

According to one aspect of the present disclosure, a device and technique for impact detection and indication is disclosed. The impact indicator includes a first tube having an outer dimension, a second tube having an inner dimension greater than the outer dimension of the first tube, and wherein at least a portion of the first tube is disposed within the second tube. A first fluid is disposed and held within the first tube via capillary action until a predetermined level of an acceleration event is received. A second fluid is disposed and held within the second tube via capillary action, and the second fluid is spaced apart from the first fluid by at least one plug. Responsive to receiving the predetermined level of the acceleration event, at least a portion of the first fluid exits the first tube and mixes into the second fluid to create a change in color of the second fluid to provide a visual indication of the acceleration event.

According to another embodiment of the present disclosure, an impact indicator includes a tube assembly having a first tube fixedly secured at least partially within a second tube. The first tube has an open end facing an interior of the second tube, and the first tube has a first fluid disposed therein in spaced apart relation to a second fluid disposed within the second tube. The first fluid and the second fluid are held within the respective first and second tubes via capillary action until a predetermined level of an acceleration event is received to cause the first fluid to exit the open end and mix with the second fluid to create a change in color of the second fluid to provide a visual indication of the acceleration event. An adhesive-backed carrier is secured to the tube assembly.

According to another embodiment of the present disclosure, an impact indicator includes a first tube having first and second ends, a second tube having first and second ends, and wherein the first tube has a length less than a length of the second tube. The first end of the first tube is open and disposed within an interior of the second tube, and the second end of the first tube and the first and second ends of the second tube are sealed. A first fluid is disposed near the second end of the first tube and is held within the first tube via capillary action until a predetermined level of an acceleration event is received. A second fluid is disposed within the second tube spaced apart from the first end of the first tube and is held within the second tube via capillary action. Responsive to receiving the predetermined level of the acceleration event, at least a portion of the first fluid exits the first end of the first tube and mixes into the second fluid to create a change in color of the second fluid to provide a visual indication of the acceleration event.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1A is a diagram illustrating an application of embodiment of an impact indicator according to the present disclosure;

FIG. 1B is a diagram illustrating an enlarged view of the impact indicator of FIG. 1A;

FIG. 2 is a diagram illustrating a cross-sectional view of a tube assembly of the impact indicator of FIGS. 1A and 1B in a non-activated state according to the present disclosure taken along the line 2-2 of FIG. 1A; and

FIG. 3 is a diagram illustrating a cross-sectional view of another embodiment of a tube assembly of the impact indicator of FIGS. 1A and 1B in a non-activated state according to the present disclosure.

### DETAILED DESCRIPTION

Embodiments of the present disclosure provide a device and technique for impact detection and indication. According to one embodiment, an impact indicator includes a first tube having an outer dimension, a second tube having an inner dimension greater than the outer dimension of the first tube, and wherein at least a portion of the first tube is disposed within the second tube. A first fluid is disposed and held within the first tube via capillary action until a predetermined level of an acceleration event is received. A second fluid is disposed and held within the second tube via capillary action, and the second fluid is spaced apart from the first fluid by at least one plug. Responsive to receiving the predetermined level of the acceleration event, at least a portion of the first fluid exits the first tube and mixes into the second fluid to create a change in color of the second fluid to provide a visual indication of the acceleration event. Embodiments of the present disclosure enable impact and/or acceleration event detection and indication utilizing a passive, small/compact indicator. Impact activation levels may be obtained over a variety of acceleration levels by selecting a certain internal cavity size of the tube(s), certain viscosity levels of fluids contained with the tube(s), and/or an amount of separation of the fluids within the tubes. Embodiments of the present disclosure provide an impact indicator that is readily affixable to a container or the like so as to provide at least an indication when a predetermined mechanical shock, or acceleration, has been inflicted on the particular container or component. Embodiments of the present disclosure also provide an impact indicator that is an irreversible, “go-no go” device for indicating that the predetermined shock has been received.

As will be described further herein, an impact indicator in accordance with the present disclosure detects when equipment or articles of manufacture have been subjected to a mechanical shock, or force, great enough to cause damage. More particularly, an impact indicator according to the present disclosure can be readily attached to a container or a product itself for monitoring when the container or product has been subjected to an acceleration, or force, great enough to cause damage to the article of interest.

One measure of the mechanical shock is the number of G's that have been experienced by the article of interest, where G is the acceleration of the earth's gravity. For example, a G-force acting on a stationary object resting on the Earth's surface is 1 G (upwards) and results from the resisting reaction of the Earth's surface bearing upwards equal to an acceleration of 1 G, and is equal and opposite to gravity. The number of G's has been variously referred to as shock, acceleration forces, or just acceleration. In effect, a G-force may be a negative acceleration, or deceleration, in that it measures the rapidity with which an object is brought to a stop (e.g., when a package or article is dropped and stops abruptly on the floor). Various devices are available to provide an indication when some level of a shock or acceleration event has occurred. For example, a number of such products are available from ShockWatch, Inc. of Dallas, Tex. (e.g., under part numbers such as #20700 (label), #22404 (tube), #32100 (clip), and #33030 (flex)). As an example, the label product is an impact detection device that senses and indicates a magnitude of shock using a tiny liquid filled glass tube inside a larger tube that can either be placed on or in the product or housed in a self-adhesive label that is affixed to a shipping package. If a package or product bearing a the label is dropped or roughly handled, the fluid held in place by capillary action in one tube leaves the tube and enters a different area of the device that changes from clear to bright red, providing evidence that excessive impact has occurred.

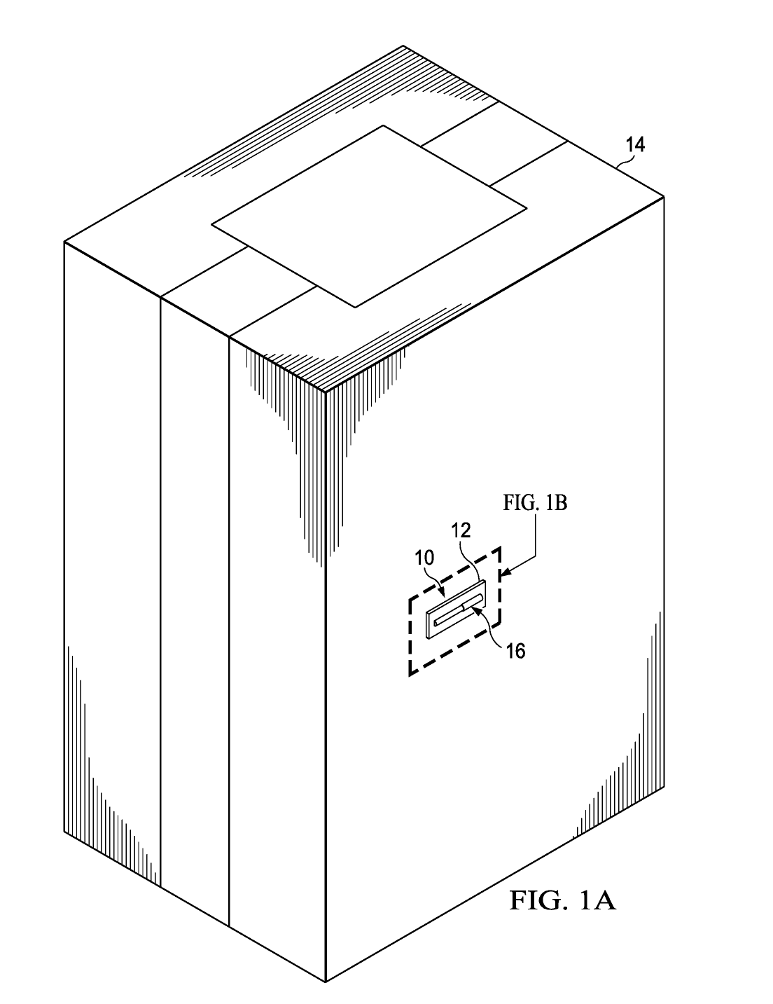

With reference now to the Figures and in particular with reference to FIGS. 1A and 1B, exemplary diagrams of an impact indicator 10 are provided in which illustrative embodiments of the present disclosure may be implemented. In FIGS. 1A and 1B, impact indicator 10 is a portable device configured to be affixed to or disposed on/within a transport container containing an object of which impact and/or acceleration events associated therewith are to be monitored. Embodiments of impact indicator 10 monitor whether an object has been exposed to an impact or some level of an acceleration event during manufacturing, storage and/or transport of the object. In some embodiments, impact indicator 10 may be affixed to a transport container using, for example, adhesive materials, permanent or temporary fasteners, or a variety of different types of attachment devices. The transport container may include a container in which a monitored object is loosely placed or may comprise a container of or be the monitored object itself. It should be appreciated that FIGS. 1A and 1B are only exemplary and are not intended to assert or imply any limitation with regard to the environments in which different embodiments may be implemented.

FIG. 1A is a diagram illustrating an embodiment of impact indicator 10 used in connection with a transport container, and FIG. 1B is a diagram illustrating an enlarged view of a portion of impact indicator of FIG. 1A. In the embodiment illustrated in FIGS. 1A and 1B, impact indicator 10 is configured to detect and indicate impact or acceleration events relative to indicator 10. For example, referring to FIG. 1A, impact indicator 10 comprises a label assembly 12 that is affixed to a container 14 for detecting and indicating impact or acceleration events relative to container 14. As described above, label assembly 12 may be affixed to an exterior surface of container 14 using, for example, adhesive materials (e.g., an adhesive-backed label or carrier), permanent or temporary fasteners, or a variety of different types of attachment devices or mechanisms. However, it should also be understood that impact indicator 10 may also be located and/or disposed within container 14. Label assembly 12 is configured to support and/or have attached thereto a tube assembly 16. In some embodiments, label assembly 12 is configured to support tube assembly 16 while enabling an indicating portion of tube assembly 16 to be visible for visually indicating whether an acceleration event has been experienced/detected. However, it should be understood that label assembly 12 may be otherwise configured. It should be further understood that in some embodiments, tube assembly 16 may be used independently of label assembly 12. For example, tube assembly 16 may be incorporated directly into container 14, located within an internal or external pocket or holding device of container 14, placed loosely within container 14, or otherwise used without label assembly 12.

As illustrated in FIG. 1B, label assembly 12 includes a support portion 22 that supports a particular portion or end of tube assembly 16. Support portion 22 is configured to enable an indicating portion 26 of tube assembly 16 to be visible to enable a user or viewer to visually detect whether an acceleration event has been experienced by and/or detected by impact indicator 10. As will be described in further detail below, indicating portion 26 of tube assembly 16 may provide a color indication of impact detection/indication (e.g., changing from one color to a different color). It should be understood that label assembly 12 may be otherwise configured to facilitate attachment of tube assembly 16 to container 14 and providing a visual indication of impact detection. Additionally, in some embodiments, support portion 22 is configured to block from view a non-indicating portion 28 of tube assembly 16 (e.g., hiding a portion of tube assembly 16 from view of a user such as via an opaque surface or element).

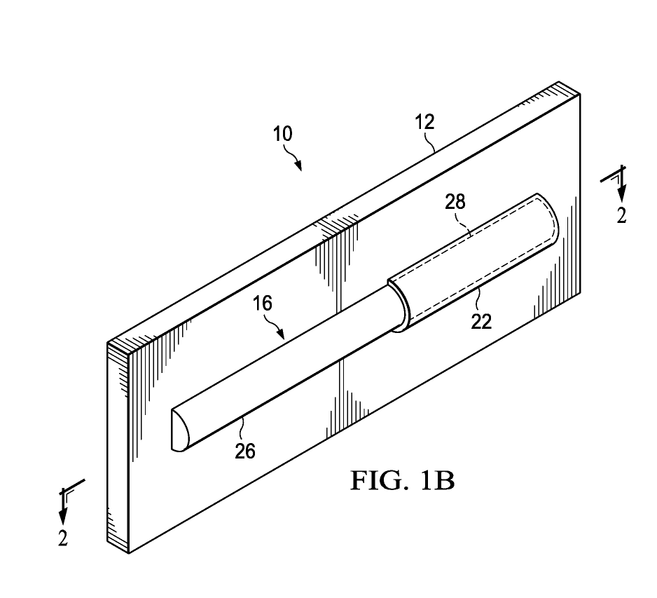

FIG. 2 is a diagram illustrating an embodiment of impact indicator 10 without label assembly 12. In the illustrated embodiment, tube assembly 12 comprises tubes 30 and 32. In the illustrated embodiment, tubes 30 and 32 are hollow, cylindrical tubes. However, it should be understood that the shape of tubes 30 and 32 may vary. In some embodiments, tubes 30 and 32 are plastic tubes. In the illustrated embodiment, tube 30 has an outer dimension (or outer diameter if cylindrical) that is less than an inner or internal dimension (or internal bore or diameter if cylindrical) of tube 32 to enable tube 30 to be inserted into tube 32. For example, in the illustrated embodiment, tube 30 has ends 36 and 38, and tube 32 has ends 42 and 44. In one embodiment, end 38 of tube 30 may be inserted into end 42 of tube 32 until end 36 of tube 30 is flush and/or aligned with (e.g., flush/aligned with or substantially flush/aligned with) end 42 of tube 32, thereby placing end 38 of tube 30 in a desired position relative to tube 32. It should be understood that the lengths, assembly of, and/or end positions of tubes 30/32 relative to each other may vary. In the illustrated embodiment, tube 30 is maintained or fixed in a desired position relative to tube 32 by adhesive 48 located at an end 50 of tube assembly 16. Adhesive 40 also seals ends 36 and 42 of tubes 30 and 32, respectively, while end 38 of tube 30 remains open. In some embodiments, end 36 of tube 30 may have its own adhesive sealing before being inserted into tube 32.

In the illustrated embodiment, tube 30 is partially filled with fluid 54. Fluid 54 is held in place within tube 30 (e.g., even when upside down/vertical) by capillary action. “Capillary action” is also sometimes described as surface tension, or “skin effect” relative to the interior surface of tube 30. Fluid 54 may also be held in position within tube 30 by a gas plug 56 (e.g., air or another type of gas) at end 38 of tube 30. By specially selecting/configuring one or more of the internal dimension or bore of tube 30, the viscosity of fluid 54, and the size of plug 56, tube assembly 16 is configured or set to require a predetermined amount of acceleration to overcome the capillary action between fluid 54 and the inner surface of tube 30 and dislodge fluid 54 from the interior of tube 30.

In the embodiment illustrated in FIG. 2, tube 32 is longer than tube 30 and, after tube 30 is inserted into tube 32, end 44 of tube 32 extends beyond end 38 of tube 30. However, it should be understood that the lengths of tube 30 and 32 may be otherwise configured while having end 44 of tube 32 extending beyond end 38 of tube 30. In the illustrated embodiment, a fluid 60 is disposed within tube 32 near end 44 of tube 32. A gas plug 62 (e.g., air or another type of gas) is located on a side of fluid toward end 42 of tube 32 such that gas plugs 56 and 62 are disposed between fluids 54 and 60. In the illustrated embodiment, end 44 of tube 32 is capped or closed by adhesive 66 (e.g., at an end 70 of tube assembly 16 opposite end 50).

Fluid 60 is also held in place within tube 32 by capillary action and plug 62. One or more of the viscosity of fluid 60, the inner or internal dimension (internal bore or inner diameter if cylindrical) of tube 32, plug 62 are specially configured/selected such that fluid 60 does not come into contact with fluid 54 before fluid 54 becomes dislodged from tube 30 by the pre-determined acceleration level.

Fluids 54 and 60 may comprise different types of materials. In at least one embodiment, fluid 54 is colored (e.g., with a dye or otherwise), and fluid 60 is transparent and is comprised of ethylene glycol from 55-70% and water from 45-30% (e.g., about 63% ethylene glycol and about 37% water). In at least one embodiment, fluid 54 is comprised of ethylene glycol from 25% to 30%, red dye from 3 to 5%, lithium chloride from 0.5% to 1.5%, and water from 60% to 70% (e.g., 30% ethylene chloride, 4% red dye, 1% lithium chloride, and 65% water).

In some embodiments, fluids 54 and 60 are of a different color so that when fluids 54 and 60 mix, the fact that they have mixed is obvious (e.g., giving a particular color indication). In yet other embodiments, fluids 54 and 60 may be of the same color (e.g., transparent, red, etc.) but when mixed, produce a particular color indication (e.g., by chemical reaction or otherwise). As indicated above, one or more of the viscosity of fluid 54, the inner or internal bore of tube 30, and plug 56 are selected/configured such that a predetermined level of acceleration event causes fluid 54 to overcome the capillary action forces to the interior surface of tube 30 where at least some portion of fluid 54 exits end 38 of tube 30, passes through plugs 56 and 62, and mixes with fluid 60 to provide a color indication of the acceleration event.

By selecting/configuring one or more of the viscosity of fluid 54, the inner bore of tube 30, and plug 56, different levels of G-force indicators 10 are provided. For example, a 50 G indicator 10 can be made with an inner bore of tube 30 at about 45 mils, an outer dimension (or diameter) of tube 30 at about 59 mils, a length of tube 30 at about 390 mils, and fluid 54 being 30% ethylene chloride, 4% red dye, 1% lithium chloride, and 65% water.

In some embodiments, to ensure that fluid 60 does not prematurely mix with fluid 54, a higher capillary force between fluid 60 and the interior surface of tube 32 than the capillary force found between fluid 54 and the interior surface of tube 30 is configured. For example, in at least one embodiment when fluid 60 is about 63% ethylene glycol and about 37% water, tube 32 may be configured with an inner bore of about 107 mils, an outer dimension (or diameter) of about 135 mils, and a length of about 800 mils to produce a greater capillary force for fluid 60/tube 32 than for fluid 54/tube 30.

Tubes 30 and 32 may be made from plastic materials such as, but not limited to, Acrylonitrile Butadiene Styrene (ABS), Polypropylene (PP), Low Density Polyethylene (LDPE), High Impact Polystyrene (HIPS) and so forth. In at least one embodiment, tubes 30 and 32 may be manufactured using injection molding. The sealing of the ends of tubes 30 and 32 (e.g., ends 36, 42, and/or 44) can be accomplished by multiple methods (e.g., using a UV triggered epoxy).

In some embodiments, tubes 30 and 32 each comprise a single tube-like structure. However, it should be understood that in some embodiments, tube 30 and/or 32 may be formed from multiple components attached together to form respective tubes 30 and 32 (e.g., multiple components attached together to form a single tube-like structure). Tubes 30 and 32 may be formed from a clear, transparent, translucent, semi-opaque, or opaque material except such that at least a portion of tube 32 (e.g., indicating portion 26) is clear, transparent, translucent, or semi-opaque to enable visibility of fluids contained therein (e.g., at least with respect to indicating portion 26).

Fluids 54 and 60 are spaced apart from each other in an non-activated state of impact indicator 10 by plugs 56 and 62. In some embodiments, plugs 56 and 62 comprise a gas such as, but not limited to, atmospheric air, and fluids 54 and 60 are liquids; however, other types of fluids (gases or liquids) may be used for fluids 54 and 60 and plugs 56 and 62. In some embodiments, fluid 54 comprises a coloring fluid or dyed fluid, and fluid 60 comprises a clear, non-colored, or different color than a color of fluid 54 that is soluble or miscible with fluid 54. In some embodiments, fluid 54 may include a colored dye such that the colored dye discolors and/or otherwise causes a color change to fluid 60 in response to contact of fluid 54 with fluid 60. It should be understood that other types of coloring mechanisms may be used to provide a visual indication of impact detection. For example, in some embodiments, fluids 50 and 60 may be selected such that a chemical reaction resulting from contact of fluid 54 with fluid 60 causes a change in color or discoloration of fluid 60. As will be described in further detail below, in response to tube assembly 16 experiencing or being subject to a predetermined level of impact or acceleration event, a droplet or portion of fluid 54 lands on and/or contacts fluid 60, thereby mixing with fluid 60 and causing a change in color or discoloration of fluid 60 to visually indicate impact detection.

Referring to FIGS. 1B and 2, end 50 of tube assembly 16 is not visible (e.g., end 50 is hidden behind an opaque support portion 22) to a user of impact device 10. End 50 where fluid 54 is located is also not visible to a user because of opaque support portion 22. End 70 of device 10 and indicating portion 26 is visible to a user (e.g., because of an opening in label assembly 12, a transparent window in label assembly 12, etc.).

In operation, if label assembly 16 and/or impact indicator 10 are subject to an acceleration of a pre-determined level, fluid 54 becomes dislodged from tube 30, passes through plugs 56 and 62, and comes into contact with fluid 60. Because fluid 54 is miscible in fluid 60, the two fluids 54 and 60 mix together. If fluid 60 is colorless, for example, fluid 60 may assume the color of fluid 54, such color being an indication of activation of indicator 10 being visible in indicating portion 26 of indicator 10. If fluid 60 is colored, for example, fluid 54 will mix with fluid 60 causing fluid 60 to undergo an observable color change, such color change being an indication of activation of indicator 10 being visible in indicating portion 26 of indicator 10.

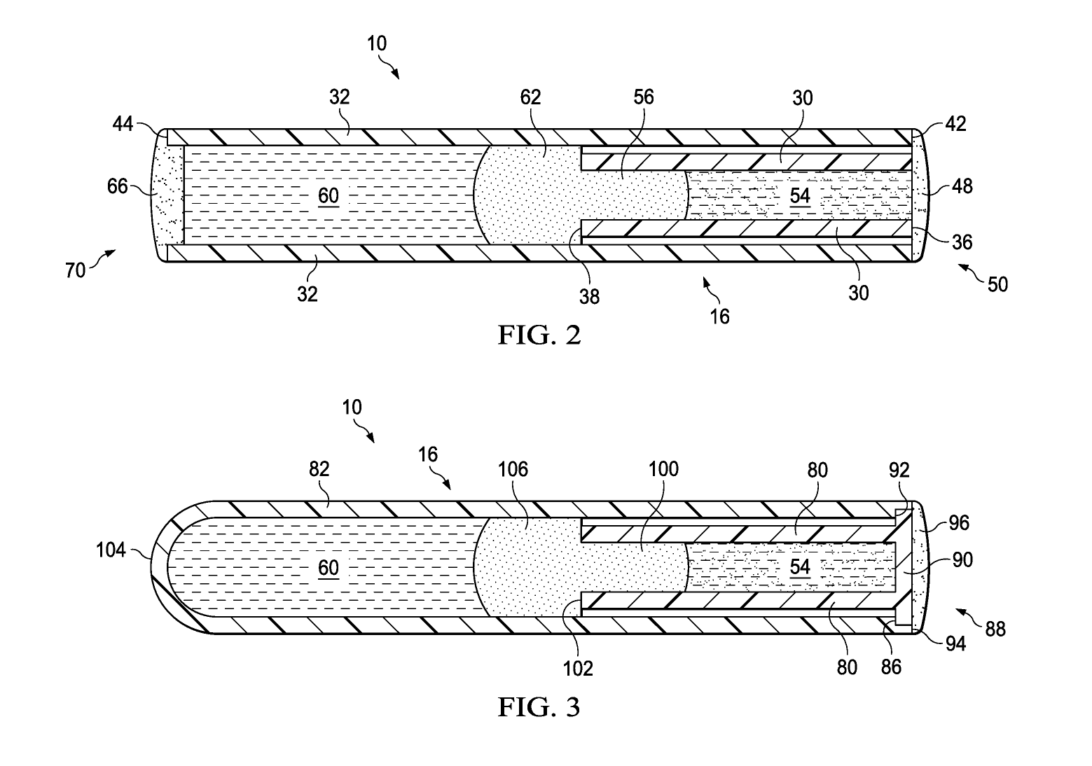

FIG. 3 is a diagram illustrating another embodiment of impact indicator 10 in accordance with the present disclosure. In the illustrated embodiment, indicator 10 (depicted without label assembly 16) includes tubes 80 and 82 that are capped from being injected molded. In FIG. 3, a cross-sectional view of indicator 10 is depicted (e.g., as if taken along the line 2-2 of FIG. 1B). Tube 80 has an outer dimension (or outer diameter if cylindrical) that is less than an internal or inner dimension (internal bore or inner diameter if cylindrical) of tube 82, thereby enabling tube 80 to be inserted into or disposed within tube 82. Tube 80 is held in place at an end 88 of indicator 10 by a cap 90 that fits into a recessed seat 92 formed at end 94 of tube 82. In some embodiments, an adhesive 96 may also be used to ensure that cap 90 remains held in place in seat 92.

In the illustrated embodiment, tube 80 is partially filled with fluid 54. As described above, fluid 54 is held in place within tube 80 (e.g., even when upside down or vertical) by capillary action. Fluid 54 may also be held in position by gas plug 100 at an end 102 of tube 80. By selecting/configuring one or more of the inner dimension of tube 80, the viscosity of fluid 54, and the size of plug 100, tube assembly 16 is configured or set to require a predetermined amount of acceleration to overcome the capillary action between fluid 54 and the inner surface of tube 80 and dislodge fluid 54 from the interior of tube 80.

As shown in FIG. 3, tube 82 is longer than tube 80 such that when tube 80 is inserted into or disposed within tube 82, an end 104 of tube 82 extends beyond open end 102 of tube 80. In the illustrated embodiment, tube 82 is formed having a closed end 104 opposite end 88. Fluid 60 is disposed within tube 82 near end 104 thereof, and a gas plug 106 is located between fluid 60 and end 102 of tube 80. As described above, plugs 100 and 106 may comprise a gas such as, but not limited to, atmospheric air; however, other types of fluids (gases or liquids) may be used for plugs 100 and 106.

Fluid 60 is also held in place in tube 82 by capillary action and plug 106. One or more of the viscosity of fluid 60, the inner dimension of tube 82, and plug 106 are selected/configured such that fluid 60 does not come into contact with fluid 54 until fluid 54 is dislodged from or exits tube 80 as a result of a predetermined level of an acceleration event.

Thus, embodiments of the present disclosure enable impact and/or acceleration event detection utilizing a passive, small/compact indicator. Further, embodiments of the present disclosure enable impact and/or acceleration event detection over an increased range of acceleration event conditions (e.g., different g-levels), thereby facilitating use of the indicator 10 with a variety of types of devices. For example, by using two tubes (e.g., 30/32 and 80/82) each with a different selected internal dimension (e.g., each with a different internal diameter or bore), along with the selection of the viscosities, amounts, and separation therebetween of fluids 54 and 60 within the respective tubes 30/32 and 80/82, indicator 10 according to the present disclosure enables greater control of impact sensitivity levels for indicator 10 activation. As an example, in some embodiments, a single combination of tubes 30 and 32 (e.g., a particular inner bore selected for tube 30 and a particular inner bore selected for tube 32) may be used to accommodate different impact sensitivity levels. For example, this same tube 30/32 configuration can accommodate different impact sensitivity levels by selecting different or particular viscosities for fluid 54 and/or 60 and/or varying/selecting the amount of gap therebetween (e.g., via plug 56 and/or plug 60). Further, embodiments of the present disclosure provide omnidirectional impact detection and indication in an irreversible device.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. An impact indicator, comprising:
a first tube having an outer dimension;
a second tube having an inner dimension greater than the outer dimension of the first tube, wherein at least a portion of the first tube is disposed within the second tube;
a first fluid disposed within the first tube, the first fluid held within the first tube via capillary action until a predetermined level of an acceleration event is received; and
a second fluid disposed within the second tube, the second fluid being miscible with the first fluid, the second fluid held within the second tube via capillary action, the second fluid spaced apart from the first fluid by at least one plug; and
wherein responsive to receiving the predetermined level of the acceleration event, at least a portion of the first fluid exits the first tube and mixes into the second fluid to create a change in color of the second fluid to provide a visual indication of the acceleration event.

2. The impact indicator of claim 1, wherein the first fluid comprises a color different than a color of the second fluid in a non-activated state of the impact indicator.

3. The impact indicator of claim 1, wherein the at least one plug comprises at least one gas plug.

4. The impact indicator of claim 1, wherein the at least one plug comprises a first gas plug disposed within the first tube and a second gas plug disposed within the second tube.

5. The impact indicator of claim 1, wherein the first fluid comprises a viscosity selected to obtain a desired activation sensitivity for the predetermined level of the acceleration event.

6. The impact indicator of claim 1, wherein an inner dimension of the first tube, an amount of separation between the first and second fluids, and the viscosity of the first fluid are selected to obtain a desired activation sensitivity for the predetermined level of the acceleration event.

7. The impact indicator of claim 1, wherein the first and second tubes comprise first and second plastic, cylindrical tubes, and wherein a length of the second tube is greater than a length of the first tube.

8. An impact indicator, comprising:
a tube assembly having a first tube fixedly secured at least partially within a second tube, the first tube having an open end facing an interior of the second tube, the first tube having a first fluid disposed therein in spaced apart relation to a second fluid disposed within the second tube, wherein the first fluid and the second fluid are held within the respective first and second tubes via capillary action until a predetermined level of an acceleration event is received to cause the first fluid to exit the open end and mix with the second fluid to create a change in color of the second fluid to provide a visual indication of the acceleration event; and
an adhesive-backed carrier secured to the tube assembly.

9. The impact indicator of claim 8, wherein the first fluid comprises a color different than a color of the second fluid in a non-activated state of the impact indicator, and wherein the second fluid is soluble with the first fluid.

10. The impact indicator of claim 8, wherein the first and second tubes comprise first and second plastic, cylindrical tubes, and wherein a length of the second tube is greater than a length of the first tube.

11. The impact indicator of claim 8, wherein the first and second fluids are held in spaced apart relation to each other in a non-activated state of the indicator by a first gas plug disposed within the first tube and a second gas plug disposed within the second tube.

12. The impact indicator of claim 8, wherein the first fluid comprises a viscosity selected to obtain a desired activation sensitivity for the predetermined level of the acceleration event.

13. The impact indicator of claim 8, wherein an inner dimension of the first tube, an amount of separation between the first and second fluids, and the viscosity of the first fluid are selected to obtain a desired activation sensitivity for the predetermined level of the acceleration event.

14. The impact indicator of claim 8, wherein the carrier impedes a view of at least a portion of the first tube containing the first fluid in a non-activated state of the indicator.

15. An impact indicator, comprising:
a first tube having first and second ends;
a second tube having first and second ends, the first tube having a length less than a length of the second tube;
wherein the first end of the first tube is open and disposed within an interior of the second tube, and wherein the second end of the first tube and the first and second ends of the second tube are sealed;
wherein a first fluid is disposed near the second end of the first tube, the first fluid held within the first tube via capillary action until a predetermined level of an acceleration event is received;
wherein a second fluid is disposed within the second tube spaced apart from the first end of the first tube, the second fluid held within the second tube via capillary action; and
wherein responsive to receiving the predetermined level of the acceleration event, at least a portion of the first fluid exits the first end of the first tube and mixes into the second fluid to create a change in color of the second fluid to provide a visual indication of the acceleration event.

16. The indicator of claim 15, wherein the first end of the second tube is disposed in alignment with the second end of the first tube.

17. The indicator of claim 15, wherein the first and second tubes comprise first and second plastic, cylindrical tubes.

18. The indicator of claim 15, wherein the first fluid comprises a color different than a color of the second fluid in a non-activated state of the impact indicator, and wherein the second fluid is soluble with the first fluid.

19. The indicator of claim 15, wherein the first and second fluids are held in spaced apart relation to each other in a non-activated state of the indicator by a first gas plug disposed within the first tube and a second gas plug disposed within the second tube.

20. The indicator of claim 15, wherein the first fluid comprises a viscosity selected to obtain a desired activation sensitivity for the predetermined level of the acceleration event.
